(19) United States
(12) Patent Application Publication
(10) Pub. No.: US 2023/0332436 A1
(43) Pub. Date: Oct. 19, 2023

(54) DOOR EXTENSION COMPONENTS TO ACCOMMODATE MULTIPLE DOOR THICKNESS

(71) Applicant: Carrier Corporation, Palm Beach Gardens, FL (US)

(72) Inventors: Jon Luebeck, Stayton, OR (US); James Huynh, Salem, OR (US)

(21) Appl. No.: 18/299,225

(22) Filed: Apr. 12, 2023

Related U.S. Application Data
(60) Provisional application No. 63/330,582, filed on Apr. 13, 2022.

(51) Int. Cl. E05B 63/00; E05B 15/00

(52) U.S. Cl. CPC E05B 63/006; E05B 15/0033

(57) ABSTRACT

An adapter set for a door handle mechanism comprising a first handle assembly and a second handle assembly includes at least one spindle adapter removably connectable to a spindle of one of the first handle assembly and the second handle assembly and at least one post adapter removably connectable to a post extending from the first handle assembly.

### CROSS-REFERENCE TO RELATED APPLICATIONS

This application claims the benefit of U.S. Application No. 63/330,582, filed Apr. 13, 2022, the contents of which are incorporated by reference herein in their entirety.

### BACKGROUND

Exemplary embodiments of the present disclosure relate to the art of a door lock, and more particularly, to modular extension components used to adapt a door lock to variable door thicknesses.

When installing traditional door handle mechanisms, it is common practice to adapt the length of one or more components which extend through the door to the thickness of the door by cutting those components to a desired size. Such a detailed adaptation of the components included of a handle mechanism has often proved to be complicated and time-consuming.

### BRIEF DESCRIPTION

According to an embodiment, an adapter set for a door handle mechanism comprising a first handle assembly and a second handle assembly includes at least one spindle adapter removably connectable to a spindle of one of the first handle assembly and the second handle assembly and at least one post adapter removably connectable to a post extending from the first handle assembly.

In addition to one or more of the features described above, or as an alternative to any of the foregoing embodiments the at least one spindle adapter further comprises a body having a first portion with a first outer diameter and a second portion with a second outer diameter. The second outer diameter is different than the first outer diameter. An opening formed in the first portion is aligned with a longitudinal axis of the body.

In addition to one or more of the features described above, or as an alternative to any of the foregoing embodiments the opening is sized to receive a distal end of the spindle therein.

In addition to one or more of the features described above, or as an alternative to any of the foregoing embodiments the second outer diameter is equal to an outer diameter of a distal end of the spindle.

In addition to one or more of the features described above, or as an alternative to any of the foregoing embodiments the at least one spindle adapter has a body and a coupling mechanism for removably connecting the at least one spindle adapter to the spindle. The coupling mechanism is embedded within the body.

In addition to one or more of the features described above, or as an alternative to any of the foregoing embodiments the coupling mechanism is a magnet.

In addition to one or more of the features described above, or as an alternative to any of the foregoing embodiments the at least one post adapter further comprises a body having a first portion with a first outer diameter and a second portion with a second outer diameter. The second outer diameter is different than the first outer diameter and an opening is formed in the second portion in alignment with a longitudinal axis of the body.

In addition to one or more of the features described above, or as an alternative to any of the foregoing embodiments the first outer diameter is equal to a diameter of the opening.

In addition to one or more of the features described above, or as an alternative to any of the foregoing embodiments the at least one post adapter further comprises a coupling mechanism for connecting the at least one post adapter to the post. The coupling mechanism including a plurality of threads.

In addition to one or more of the features described above, or as an alternative to any of the foregoing embodiments the at least one spindle adapter further comprises a plurality of spindle adapters, the plurality of spindle adapters being substantially identical.

In addition to one or more of the features described above, or as an alternative to any of the foregoing embodiments the at least one spindle adapter further comprises a plurality of spindle adapters. A configuration of the plurality of spindle adapters varies.

According to an embodiment, a door handle mechanism mountable to a door includes a first handle assembly including a first spindle and at least one post, a second handle assembly including a second spindle, a latch, at least one first spindle adapter removably connectable to the first spindle, at least one second spindle adapter removably connectable to the second spindle, and at least one post adapter removably connectable to the at least one post.

In addition to one or more of the features described above, or as an alternative to any of the foregoing embodiments a configuration of the at least one first spindle adapter is different than a configuration of the at least one second spindle adapter.

In addition to one or more of the features described above, or as an alternative to any of the foregoing embodiments one or both of the at least one first spindle adapter and the at least one second spindle adapter further comprises a body having a first portion with a first outer diameter and a second portion with a second outer diameter. The second outer diameter is different than the first outer diameter. An opening formed in the first portion is aligned with a longitudinal axis of the body.

In addition to one or more of the features described above, or as an alternative to any of the foregoing embodiments the opening is sized to receive a distal end of one of the first spindle and the second spindle therein.

In addition to one or more of the features described above, or as an alternative to any of the foregoing embodiments the second outer diameter is substantially equal to an outer diameter of a distal end of one of the first spindle and the second spindle.

In addition to one or more of the features described above, or as an alternative to any of the foregoing embodiments the body includes a coupling mechanism embedded therein.

In addition to one or more of the features described above, or as an alternative to any of the foregoing embodiments the at least one first spindle adapter further comprises a plurality of first spindle adapters and the at least one second spindle adapter further comprises a plurality of second spindle adapters. The plurality of first spindle adapters is greater than the plurality of second spindle adapters.

In addition to one or more of the features described above, or as an alternative to any of the foregoing embodiments the at least one post adapter further comprises a body having a first portion with a first outer diameter and a second portion with a second outer diameter. The second outer diameter is different than the first outer diameter. An opening is formed in the second portion aligned with a longitudinal axis of the body.

In addition to one or more of the features described above, or as an alternative to any of the foregoing embodiments the at least one post adapter further comprises a coupling mechanism for connecting the at least one post adapter to the at least one post, the coupling mechanism including a plurality of threads.

### BRIEF DESCRIPTION OF THE DRAWINGS

The following descriptions should not be considered limiting in any way. With reference to the accompanying drawings, like elements are numbered alike:

FIG. 1 is a schematic plan view of a door including a door handle mechanism according to an embodiment;

FIG. 2 is a cross-sectional view of an exemplary door handle mechanism according to an embodiment;

FIG. 3 is an exploded perspective view of a portion of an exemplary door handle mechanism including at least one adapter according to an embodiment;

FIG. 4 is a perspective view of the portion of the door handle mechanism of FIG. 3 with a plurality of adapters installed according to an embodiment; and

FIG. 5 is a perspective view of an exemplary door having a first door handle mechanism and a second door handle mechanism according to an embodiment.

### DETAILED DESCRIPTION

A detailed description of one or more embodiments of the disclosed apparatus and method are presented herein by way of exemplification and not limitation with reference to the Figures.

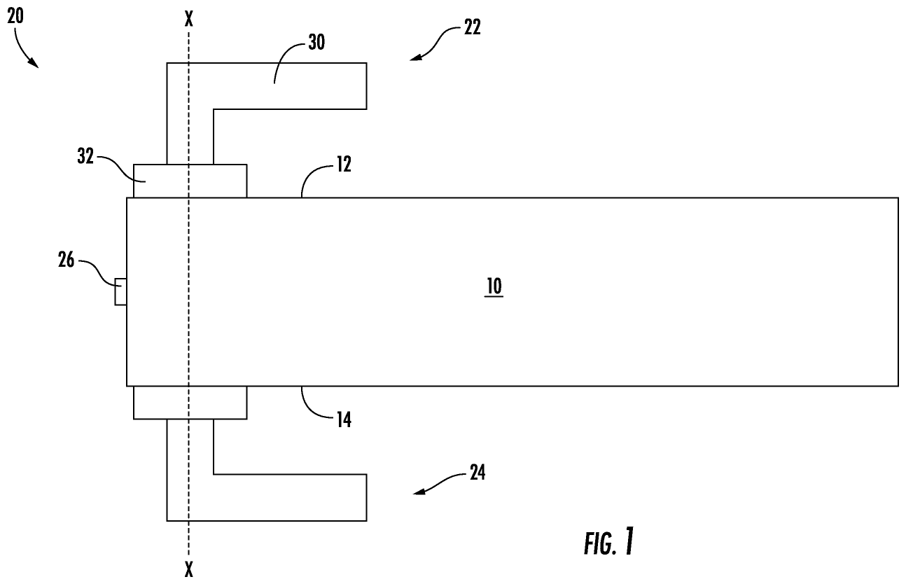

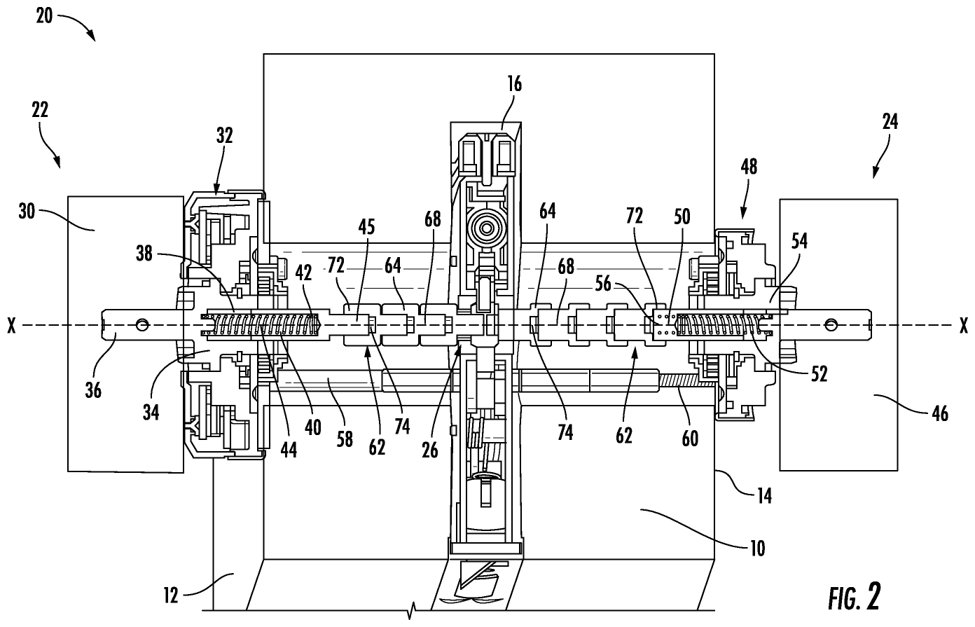

With reference now to FIGS. 1 and 2, an exemplary door handle mechanism 20 connectable to a door 10 is illustrated according to an embodiment. The door handle mechanism includes a first handle assembly 22 positionable adjacent a first side 12 of the door 10 and a second handle assembly 24 positionable adjacent to a second, opposite side 14 of the door 10. As will be described in more detail below, the first and second door handle assemblies 22, 24 are connectable to one another and to a latch 26 arranged at least partially within an opening 16 (FIG. 2) formed in the door 10, such as at a central location between the first side 12 and the second side 14 of the door 10.

The first handle assembly 22 includes a first handle 30 and a rosette 32. The rosette 32 includes a rotatable cylinder 34 having a connector 36 that protrudes from a first side of the cylinder 34 facing away from the door 10. The first handle 30 is coupled to the connector 36 and is operable to rotate the cylinder 34 about its axis X. An opening 38 axially aligned with the axis of rotation X of the cylinder 34 is formed in a second side of the cylinder 34, closest to the door 10. A first spindle portion 40 is at least partially arranged within the opening 38. In the illustrated, non-limiting embodiment, the first spindle portion 40 has a hollow cavity 42 formed therein and a biasing mechanism 44, for example a coil spring, may be positioned between an interior surface of the cylinder 34 and an interior surface of the cavity 42 formed in the first spindle portion 40. A distal end 45 of the first spindle portion 40 is typically connected to the latch 26 and the biasing force of the biasing mechanism 44 functions to bias the first spindle portion 40 into engagement with the latch 26.

The second handle assembly 24 similarly includes a second handle 46 and a second rosette 48. In an embodiment, the second handle assembly 24 is substantially similar to the first handle assembly 22. However, the second handle 46 may be a different type of handle than the first handle. For example, one may be a knob whereas the other may be a lever. As shown in FIG. 2, a second spindle portion 50 is receivable within the opening 52 formed in the rotatable cylinder 54 of the rosette 48, and a distal end 56 of the second spindle portion 50 is also typically connected into the latch 26. The first spindle portion 40 and the second spindle portion 50 may have similar or identical configurations, or may have different configurations, as shown in the FIG. For example, the distal end 45 of the first spindle portion 40 has a reduced outer diameter relative to the remainder of the first spindle portion 40 whereas the second spindle portion 50 has a substantially constant outer diameter. However, it should be understood that a spindle portion 40, 50 having any suitable configuration is within the scope of the disclosure.

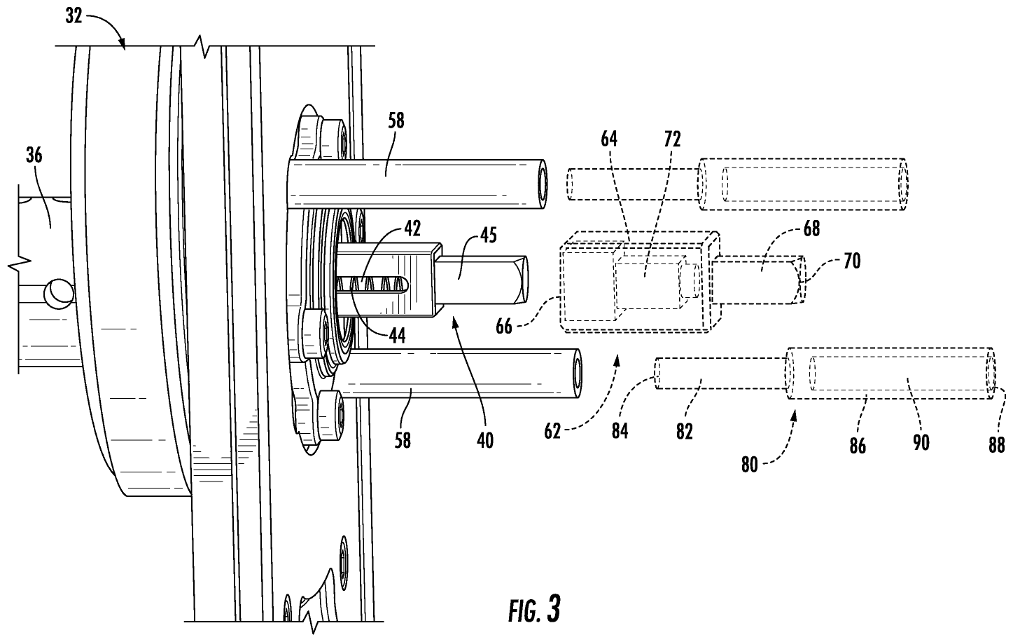

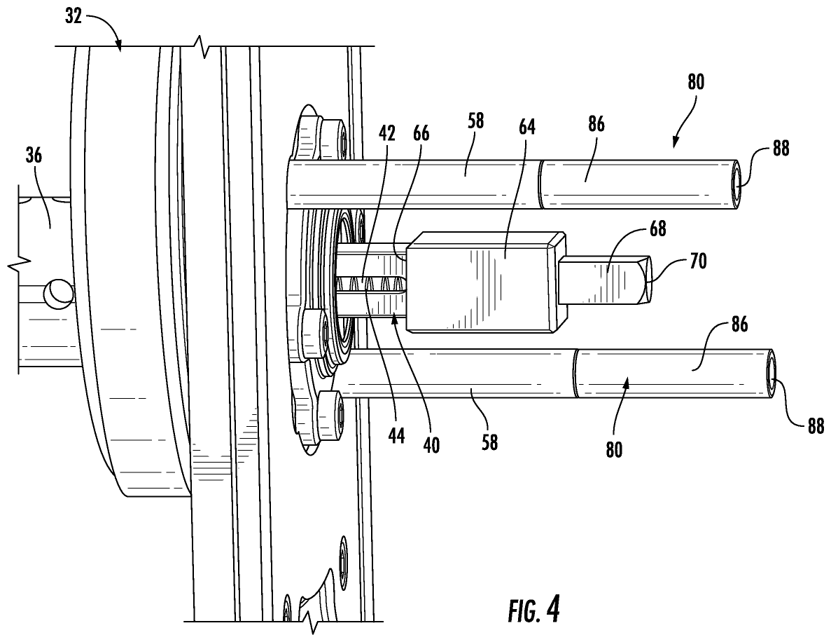

In an embodiment, one or more posts 58 extend from the rosette 32 of the first handle assembly 22, through the door 10, to the rosette 48 of the second handle assembly 24. One or more fasteners 60 located at the rosette 48 of the second handle assembly 24 are connectable to the ends of the at least one post 58 to couple the first and second handle assemblies 22, 24 to one another about the door 10. In embodiments including a plurality of posts 58, the posts 58 may, but need not be equidistantly spaced from the spindle 40, 50. Although only a single post 58 is shown in the door handle mechanism 20 of FIG. 1 and two posts 58 are shown in the embodiments of FIGS. 3 and 4, it should be understood that embodiments having more than two posts 58, such as three posts or four posts for example, are also contemplated herein.

Because door handle mechanisms may be used on a door having any thickness within a suitable range of door thicknesses, the spindle portions and the posts of existing door handle mechanisms are typically designed with a fixed length determined based on the maximum door thickness of the range and are cut to size during installation. With continued reference to FIG. 2, and further reference to FIGS. 3 and 4, to adapt a door handle mechanism 20 to any suitable door thickness, the door handle mechanism 20 additionally includes at least one modular extension or adapter associated with one or more of the spindle portions 40, 50 and the posts 58.

A spindle adapter 62 connectable to a respective one of the first and second spindle portions 40, 50 includes a body having a first portion 64 arranged at a first end 66 and a second portion 68 arranged at a second, opposite end 70. The first portion 64 has a generally constant first outer diameter and the second portion 68 has a generally constant second outer diameter different from the first outer diameter. In the illustrated, non-limiting embodiment, the first outer diameter of the spindle adapter 62 is larger than the second outer diameter. However, in other embodiments, the second outer diameter may be equal to or larger than the first outer diameter. In an embodiment, the first outer diameter is substantially equal to or is larger the maximum outer diameter of a corresponding spindle portion 40, 50. For example, as shown in FIG. 2, the first outer diameter of a spindle adapter 62 suitable for use with the first spindle portion 40 (also referred to herein as a first spindle adapter), is slightly larger than the diameter of the first spindle portion 40 receivable within the opening 38. Similarly, the first outer diameter of a spindle adapter 62 suitable for use with the second spindle portion 50 (also referred to herein as a second spindle adapter) may be slightly larger than the diameter of the second spindle portion 50. The configuration of the first spindle portion 40 is different than the configuration of the second spindle portion 50, and therefore the configuration of the spindle adapter 62 connectable to each of the first and second spindle portions 40, 50 will also vary. However, embodiments where the spindle portions 40, 50 and/or the spindle adapters 62 usable with the spindle portions 40, 50 are identical are also within the scope of the disclosure.

An opening or cavity 72 is formed at a first end 66 of the spindle adapter 62 and extends over at least a portion of the axial length of the first portion thereof. The cavity 72 may be generally constant in size or may vary. As shown, the cavity 72 is complementary to the distal end of a spindle portion 40, 50 and/or to a portion of another spine adapter 62 receivable therein. In the illustrated, non-limiting embodiment, the diameter of the cavity 72 is substantially equal to the outer diameter of the distal end of the corresponding spindle portion 40, 50 and/or to the second outer diameter of the second portion 68.

The spindle adapter 62 includes a coupling mechanism configured to couple the spindle adapter 62 to a corresponding spindle portion 40, 50 or to another spindle adapter. In the illustrated, non-limiting embodiment, the coupling mechanism is a magnet 74 embedded within the interior of the body of the spindle adapter 62. The magnet 74 may be positioned generally adjacent an internal end of the cavity 78. However, it should be understood that the magnet 74 may be arranged at another suitable location about the spindle adapter 62, for example based on the strength of the magnet 74. The spindle portion 40, 50 and/or the spindle adapter 62 may be at least partially formed from a magnetic material. Accordingly, the attraction between the magnet 74 located within the spindle adapter 62 and the portion of the component receivable within the cavity 72 is sufficient to couple the spindle adapter 62 to the spindle portion 40, 50 and/or another spindle adapter 62. It should be understood that in other embodiments, the spindle adapter 62 may use another type of coupling mechanism, such as a threaded connection for example.

As shown in FIG. 2, a plurality of spindle adapters 62 may be stacked along an axis of the spindle between a respective spindle portion 40, 50 and the latch 26. Further, the total number of spindle adapters 62 connected to the first spindle portion 40 may but need not be equal to the total number of spindle adapters 62 connected to the second spindle portion 50. For example, in the illustrated, non-limiting embodiment, three spindle adapters 62 are connected to the first spindle portion 40 and four spindle adapters 62 are connected to the second spindle portion 50. However, it should be understood that the total number of spindle adapters 62 connectable to each spindle portion 40, 50 will vary based on the total thickness of the door 10 and the position of the latch 26.

Although each of the spindle adapters 62 shown connected to each respective spindle portion 40, 50 is substantially identical, it should be understood that in an embodiment, spindle adapters 62 having different axial lengths may be connected to the same spindle portion 40, 50. Inclusion of spindle adapters 62 having different lengths may reduce the total number of adapters need in an application. The spindle adapters 62 are intended to provide course adjustment of the length of the spindle. Once a suitable number of spindle adapters 62 have been connected to a spindle 40, 50 to connect the spindle 40, 50 to the latch, fine adjustment of the overall length is performed by the biasing mechanism 44, such as by further compressing the biasing mechanism 44 as needed.

The door handle mechanism may additionally include at least one post adapter 80 connectable to a post 58. A post adapter 80 may have a similar configuration to a spindle adapter 62. As shown, the post adapter 80 has a body including a first portion 82 arranged at a first end 84 and a second portion 86 arranged at a second end 88. The first portion 82 has a generally constant first outer diameter and the second portion 86 has a generally constant second outer diameter different from the first outer diameter. In the illustrated, non-limiting embodiment, the first outer diameter of the post adapter 80 is smaller than the second outer diameter. However, in other embodiments, the first outer diameter may be equal to or larger than the second outer diameter. In an embodiment, the second outer diameter is substantially equal to the outer diameter of a post 58.

An opening or cavity 90 is formed at the second end 88 of the post adapter 80 and extends over at least a portion of the axial length of the second portion thereof. The cavity 90 may be generally constant in size or may vary. As shown, the interior diameter of the cavity 90 is complementary to the outer diameter of the first portion 82 such that a first portion 82 of another adapter is receivable within the cavity 90.

The post adapter 80 may have any suitable coupling mechanism for connecting to the post 58 or to another post adapter. In the illustrated, non-limiting embodiment, a plurality of threads are formed about an exterior of the first portion 82. The post 58 may have an internal cavity (not shown) with a plurality of threads complementary to the threads of the first portion 82 formed therein. Similarly, the internal cavity 90 of the post adapter 80 may include a plurality of threads configured to engage with and couple the plurality of threads formed about a first portion 82 of another post adapter 80. Accordingly, one or more post adapters 80 may be connected to a post 58 to span the distance between the post 58 and the rosette 48.

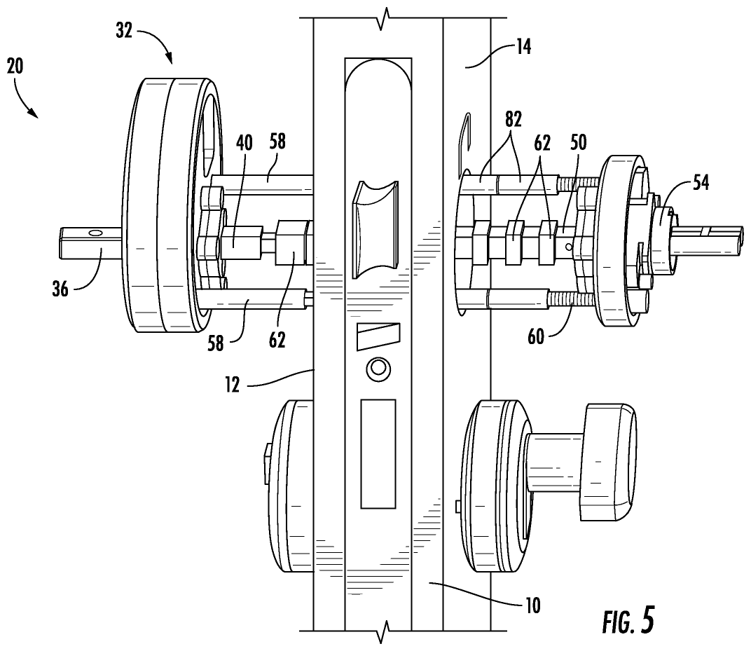

As shown, the axial length of the post adapter may be greater than the axial length of a respective spindle adapter 62. Accordingly, the total number of post adapters required in an application will be different, and typically fewer than the number of spindle adapters 62. Further, although the post adapters 80 are described with respect to the posts 58 extending from the rosette 32 of the door handle mechanism 20, it should be understood that the post adapter 80 may be suitable for use with any post of any type of door handle mechanism. For example, as shown in FIG. 5, another type of door handle mechanism, a key override mechanism for example, is mounted vertically beneath the door handle mechanism 20. The key override mechanism may similarly include posts (not shown) extending between the two portions disposed at opposing sides of the door, and one or more post adapters may be coupled to the posts.

A door handle mechanism 20 including one or more spindle adapters and post adapters as described herein, would allow for quicker installation by eliminating the need to cut components to length in the field and allowing for adjustment without any specialized tools. In addition, the total number of products required to for use with varying door thicknesses can be reduced.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An adapter set for a door handle mechanism comprising a first handle assembly and a second handle assembly, the adapter set comprising:
at least one spindle adapter removably connectable to a spindle of one of the first handle assembly and the second handle assembly; and
at least one post adapter removably connectable to a post extending from the first handle assembly.

2. The adapter set of claim 1, wherein the at least one spindle adapter further comprises:
a body having a first portion with a first outer diameter and a second portion with a second outer diameter, the second outer diameter being different than the first outer diameter; and
an opening being formed in the first portion, the opening being aligned with a longitudinal axis of the body.

3. The adapter set of claim 2, wherein the opening is sized to receive a distal end of the spindle therein.

4. The adapter set of claim 2, wherein the second outer diameter is equal to an outer diameter of a distal end of the spindle.

5. The adapter set of claim 1, wherein the at least one spindle adapter has a body and a coupling mechanism for removably connecting the at least one spindle adapter to the spindle, the coupling mechanism being embedded within the body.

6. The adapter set of claim 5, wherein the coupling mechanism is a magnet.

7. The adapter set of claim 1, wherein the at least one post adapter further comprises:
a body having a first portion with a first outer diameter and a second portion with a second outer diameter, the second outer diameter being different than the first outer diameter; and
an opening being formed in the second portion, the opening being aligned with a longitudinal axis of the body.

8. The adapter set of claim 7, wherein the first outer diameter is equal to a diameter of the opening.

9. The adapter set of claim 7, wherein the at least one post adapter further comprises a coupling mechanism for connecting the at least one post adapter to the post, the coupling mechanism comprising a plurality of threads.

10. The adapter set of claim 1, wherein the at least one spindle adapter further comprises a plurality of spindle adapters, the plurality of spindle adapters being substantially identical.

11. The adapter set of claim 1, wherein the at least one spindle adapter further comprises a plurality of spindle adapters, wherein a configuration of the plurality of spindle adapters varies.

12. A door handle mechanism mountable to a door, the door handle mechanism comprising:
a first handle assembly comprising a first spindle and at least one post;
a second handle assembly comprising a second spindle;
a latch;
at least one first spindle adapter removably connectable to the first spindle;
at least one second spindle adapter removably connectable to the second spindle; and
at least one post adapter removably connectable to the at least one post.

13. The door handle mechanism of claim 12, wherein a configuration of the at least one first spindle adapter is different than a configuration of the at least one second spindle adapter.

14. The door handle mechanism of claim 12, wherein one or both of the at least one first spindle adapter and the at least one second spindle adapter further comprise:
a body having a first portion with a first outer diameter and a second portion with a second outer diameter, the second outer diameter being different than the first outer diameter; and
an opening being formed in the first portion, the opening being aligned with a longitudinal axis of the body.

15. The door handle mechanism of claim 14, wherein the opening is sized to receive a distal end of one of the first spindle and the second spindle therein.

16. The door handle mechanism of claim 14, wherein the second outer diameter is substantially equal to an outer diameter of a distal end of one of the first spindle and the second spindle.

17. The door handle mechanism of claim 14, wherein the body includes a coupling mechanism embedded therein.

18. The door handle mechanism of claim 12, wherein the at least one first spindle adapter further comprises a plurality of first spindle adapters and the at least one second spindle adapter further comprises a plurality of second spindle adapters, wherein the plurality of first spindle adapters is greater than the plurality of second spindle adapters.

19. The door handle mechanism of claim 12, wherein the at least one post adapter further comprises:
a body having a first portion with a first outer diameter and a second portion with a second outer diameter, the second outer diameter being different than the first outer diameter; and
an opening being formed in the second portion, the opening being aligned with a longitudinal axis of the body.

20. The door handle mechanism of claim 19, wherein the at least one post adapter further comprises a coupling mechanism for connecting the at least one post adapter to the at least one post, the coupling mechanism including a plurality of threads.
